(19) United States
(12) Patent Application Publication
(10) Pub. No.: US 2025/0278004 A1
(43) Pub. Date: Sep. 4, 2025

(54) ELECTRIC PAPER DISPLAY PANEL

(71) Applicant: E Ink Holdings Inc., Hsinchu (TW)

(72) Inventors: Chao Feng Sung, Hsinchu (TW); Chen Chu Tsai, Hsinchu (TW); Ming-Huan Yang, Hsinchu (TW); Wei Te Li, Hsinchu (TW)

(73) Assignee: E Ink Holdings Inc., Hsinchu (TW)

(21) Appl. No.: 19/063,323

(22) Filed: Feb. 26, 2025

(30) Foreign Application Priority Data
Mar. 1, 2024 (TW) 113107346

(51) Int. Cl. G02F 1/16755; G02F 1/167; G02F 1/1676; G02F 1/1679

(52) U.S. Cl. CPC G02F 1/16755; G02F 1/167; G02F 1/1676; G02F 1/1679

(57) ABSTRACT

An electric paper display panel includes a first substrate, a second substrate, in which the first substrate is disposed opposite to the second substrate, a display medium layer disposed between the first substrate and the second substrate, and a package layer disposed on the first substrate and including a top package portion, a side package portion, and a bottom package portion that are formed in a one-piece form. The top package portion overlaps the first substrate. The side package portion extends from the first substrate to the second substrate. The bottom package portion covers a backside surface of the second substrate.

### CROSS-REFERENCE TO RELATED APPLICATION

This application claims the priority benefit of Taiwan application serial no. 113107346, filed on Mar. 1, 2024. The entirety of the above-mentioned patent application is hereby incorporated by reference herein and made a part of this specification.

### BACKGROUND

### Technical Field

The disclosure relates to a display panel, and more particularly, to an electric paper display panel.

### Description of Related Art

An electric paper display panel has advantages of light weight and thickness. If a soft substrate is used, it may be designed to be flexible and unbreakable. Generally speaking, a display panel includes a substrate and has a display area and a non-display area, that is, a border area. At present, packaging of the display panel usually requires a certain border width to be reserved, resulting in obvious borders on a product that affect usage and experience for consumers.

### SUMMARY

The disclosure provides an electric paper display panel, which has a narrow border and good water resistance and packaging effect.

An electric paper display panel in the disclosure includes a first substrate, a second substrate, in which the first substrate is disposed opposite to the second substrate, a display medium layer disposed between the first substrate and the second substrate, and a package layer disposed on the first substrate and including a top package portion, a side package portion, and a bottom package portion that are formed in a one-piece form. The top package portion overlaps the first substrate. The side package portion extends from the first substrate to the second substrate. The bottom package portion covers a backside surface of the second substrate.

In an embodiment of the disclosure, the second substrate has a bottom corner portion that extends beyond the display medium layer. The side package portion of the package layer is attached to the bottom corner portion of the second substrate. The first substrate has a top corner portion that extends beyond the display medium layer. The electric paper display panel further includes a sealing material. The sealing material is disposed between the first substrate and the second substrate, and seals the display medium layer at the bottom corner portion and the top corner portion.

In an embodiment of the disclosure, the electric paper display panel further includes an adhesion layer attaching the package layer to the first substrate, the second substrate, and the display medium layer.

In an embodiment of the disclosure, the electric paper display panel further includes a first electrode layer and a second electrode layer. The first electrode layer is disposed between the first substrate and the display medium layer, and the second electrode layer is disposed between the second substrate and the display medium layer. Materials of the first electrode layer and the second electrode layer include indium tin oxide (ITO), aluminum, poly(3,4-ethylenedioxythiophene) (PEDOT), silver glue, carbon glue, or a combination thereof. Materials of the first electrode layer and the second electrode layer are stretchable conductive materials.

In an embodiment of the disclosure, materials of the first substrate and the second substrate include glass, metal, or polymers with waterproof properties.

In an embodiment of the disclosure, at least one of the first substrate, the second substrate, and the package layer includes a body material and a waterproof material disposed in the body material. The waterproof material includes silicon oxide, silicon nitride, or silicon oxynitride.

In an embodiment of the disclosure, a material of the package layer includes polychlorotrifluoroethylene (PCTFE), cyclic olefin copolymer (COC), a composite material of polychlorotrifluoroethylene (PCTFE) and cyclic olefin copolymer (COC), a composite material of polychlorotrifluoroethylene (PCTFE) and polyethylene terephthalate (PET), or a combination thereof.

In an embodiment of the disclosure, the package layer includes a polymer material and an inorganic waterproof layer disposed in the polymer material. A material of the inorganic waterproof layer includes silicon oxide, silicon nitride, silicon oxynitride, or a combination thereof, and the polymer material includes polyethylene terephthalate, polyimide, polyethylene naphthalate, or a combination thereof.

In an embodiment of the disclosure, the package layer has stretchability.

In an embodiment of the disclosure, the electric paper display panel further includes a waterproof glue disposed along a side wall of the side package portion.

Based on the above, in the electric paper display panel according to the embodiment of the disclosure, the package layer with waterproof properties and plasticity is used to three-dimensionally encapsulate the substrate and display medium layer. In this way, the volume increase of the electric paper display panel due to a package structure is not obvious, which helps to achieve a narrow-border package structure. In addition, under such a thin and narrow package, the package layer may effectively provide a waterproof function.

### BRIEF DESCRIPTION OF THE DRAWINGS

FIG. 1 is a schematic view of a semi-finished electric paper display panel according to an embodiment of the disclosure.

FIG. 2 is a schematic exploded view of some components of the semi-finished electric paper display panel in FIG. 1.

FIG. 3 is a schematic partial top view of a semi-finished electric paper display panel according to an embodiment of the disclosure.

FIGS. 4 to 6 schematically show a portion of processes of manufacturing an electric paper display panel.

FIG. 7 is a three-dimensional view of an electric paper display panel from a top view according to an embodiment of the disclosure.

FIG. 8 is a three-dimensional view of an electric paper display panel from a bottom view according to an embodiment of the disclosure.

FIG. 9 is a partial bottom view of an electric paper display panel according to an embodiment of the disclosure.

FIG. 10 is a schematic partial top view of a semi-finished electric paper display panel according to an embodiment of the disclosure.

FIG. 11 is a schematic partial top view of a semi-finished electric paper display panel according to an embodiment of the disclosure.

FIG. 12A is a schematic partial cross-sectional view of a semi-finished electric paper display panel according to an embodiment of the disclosure.

FIG. 12B is schematic partial cross-sectional view of a semi-finished electric paper display panel according to an embodiment of the disclosure.

FIG. 13A is a schematic partial cross-sectional view of an electric paper display panel made of the semi-finished electric paper display panel in FIG. 12A.

FIG. 13B is a schematic partial cross-sectional view of an electric paper display panel made of the semi-finished electric paper display panel in FIG. 12B.

FIGS. 14A and 14B are two schematic partial cross-sectional views of an electric paper display panel according to an embodiment of the disclosure.

FIG. 15 is a schematic perspective view of a semi-finished electric paper display panel according to an embodiment of the disclosure.

FIG. 16 is a partial top view of the semi-finished electric paper display panel in FIG. 15.

FIGS. 17A and 17B are two schematic partial cross-sectional views of a semi-finished electric paper display panel.

FIG. 18A is a schematic partial cross-sectional view of an electric paper display panel according to an embodiment of the disclosure.

FIG. 18B is a schematic partial cross-sectional view of an electric paper display panel according to an embodiment of the disclosure.

### DETAILED DESCRIPTION OF DISCLOSED EMBODIMENTS

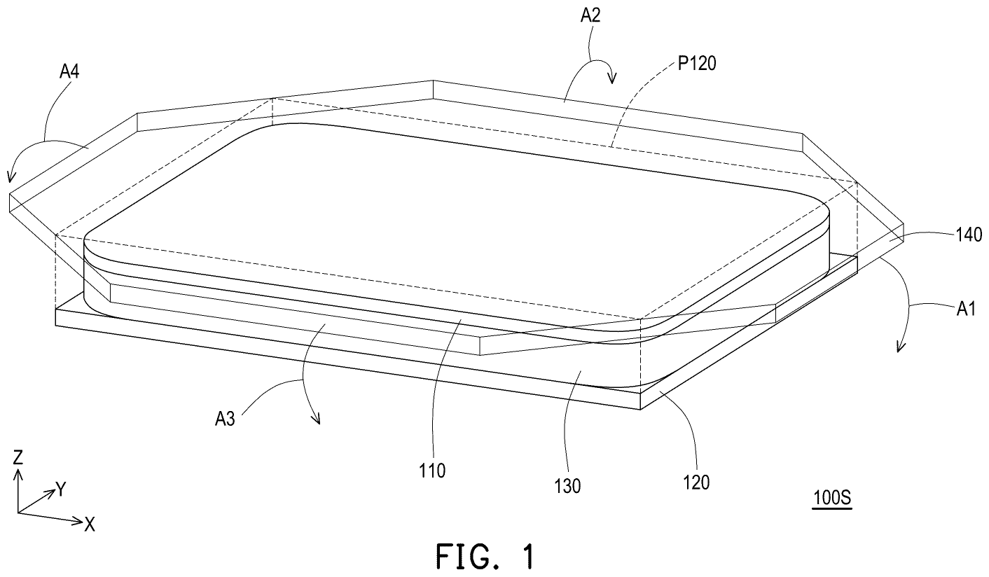

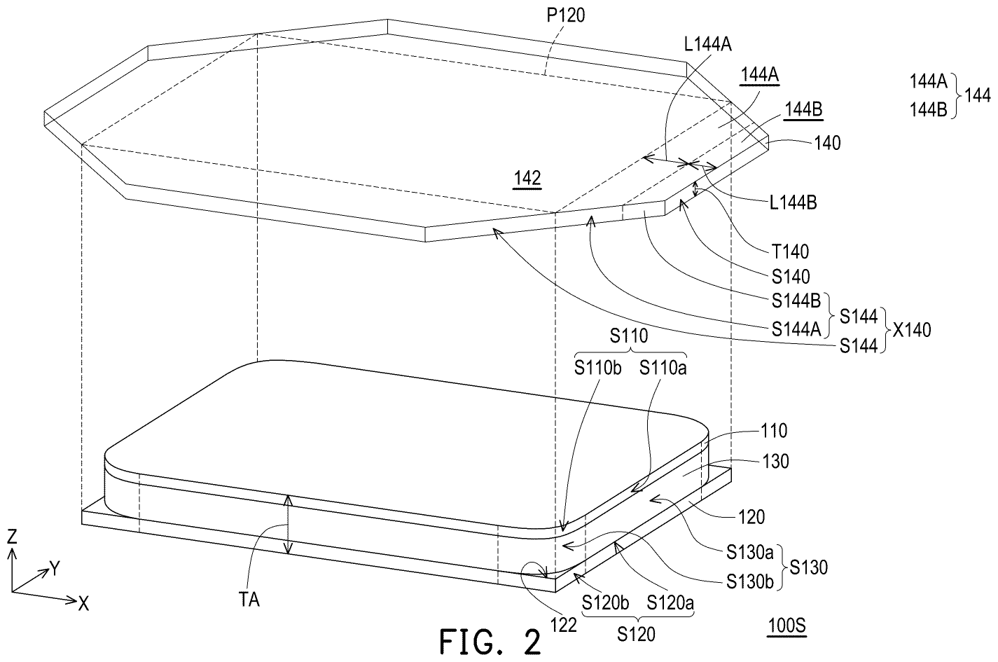

FIG. 1 is a schematic view of a semi-finished electric paper display panel according to an embodiment of the disclosure. FIG. 2 is a schematic exploded view of some components of the semi-finished electric paper display panel in FIG. 1. In FIGS. 1 and 2, a semi-finished electric paper display panel 100S includes a first substrate 110, a second substrate 120, a display medium layer 130, and a package layer 140. The first substrate 110 is disposed opposite to the second substrate 120, and the display medium layer 130 is disposed between the first substrate 110 and the second substrate 120. In some embodiments, the display medium layer 130 may be a package layer of an electric paper display material. The electric paper display material may include an electrophoretic material, an electrowetting material, or the like, and the electric paper display material may be packaged into the display medium layer 130 using microcapsules, microcups, or similar methods. The package layer 140 is disposed on the first substrate 110, and specifically, the first substrate 110 is located between the package layer 140 and the display medium layer 130.

For illustrative purposes, some components are omitted in FIGS. 1 and 2, but it is not intended to limit the semi-finished electric paper display panel 100S to only include the components presented in the figures. For example, the semi-finished electric paper display panel 100S may further include at least one electrode layer. The electrode layer may include, for example, a first electrode layer disposed between the first substrate 110 and the display medium layer 130 or a second electrode layer disposed between the second substrate 120 and the display medium layer 130. In some embodiments, the semi-finished electric paper display panel 100S may further include a circuit board and a driving circuit disposed on the circuit board. The circuit board is attached to the second substrate 120 and used to transmit a signal between the driving circuit and the display medium layer 130 (the electrode layer). In some embodiments, the semi-finished electric paper display panel 100S may further include other components such as a touch electrode and a sensor. For convenience of description, FIG. 2 shows a schematic view of a stack structure in which the package layer 140 separates the first substrate 110, the second substrate 120, and the display medium layer 130.

As shown in FIGS. 1 and 2, a side wall S110 of the first substrate 110 and a side wall S130 of the display medium layer 130 are aligned with each other. The side wall S110 of the first substrate 110 may include a middle section S110a and a corner section S110b, and the side wall S130 of the display medium layer 130 may include a middle section S130a and a corner section S130b. The middle section S110a and the middle section S130a indicated by marked lines in FIG. 2 both extend straight along a Y direction. The corner section S110b is connected to the middle section S110a and is bent to be non-parallel to the Y direction. Similarly, the corner section S130b is connected to the middle section S130a and is bent to be non-parallel to the Y direction. A side wall S120 of the second substrate 120 extends substantially straight along the Y direction. According to a configuration relationship with the display medium layer 130, the side wall S120 of the second substrate 120 may include a middle section S120a and a corner section S120b. The middle section S120a may be a portion in which the side wall S120 is aligned with the middle section S130a of the side wall S130, and the corner section S120b may be a portion protruding outward from the middle section S120a. The corner section S120b does not overlap the side wall S110 or the side wall S130. Meanwhile, the second substrate 120 has a bottom corner portion 122 surrounded by the corner section S130b of the display medium layer 130 to the corner section S120b of the second substrate 120.

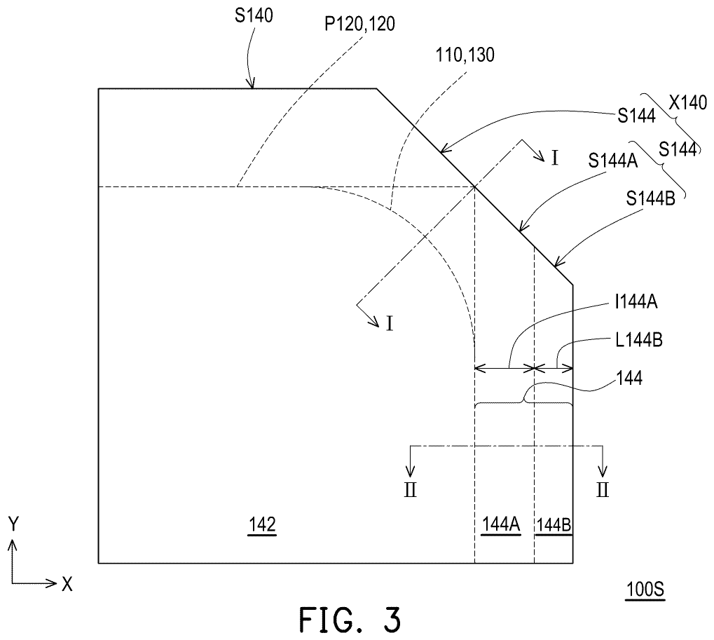

FIG. 3 is a schematic partial top view of a semi-finished electric paper display panel according to an embodiment of the disclosure. In some embodiments, when viewed along a Z direction, the first substrate 110 and the display medium layer 130 have substantially the same shape, but a shape of the second substrate 120 is different from those of the first substrate 110 and the display medium layer 130. For example, the first substrate 110 and the display medium layer 130 have a round-corner rectangular shape when viewed along the Z direction, and the second substrate 120 has a rectangular shape when viewed along the Z direction. Maximum lengths of the first substrate 110, the display medium layer 130, and the second substrate 120 along an X direction are equal to one another, and maximum lengths along the Y direction are also equal to one another, for example. However, corners of the first substrate 110 and the display medium layer 130 are rounded, while a corner of the second substrate 120 is substantially a right angle. Therefore, the second substrate 120 has the bottom corner portion 122 that extends beyond at least one of the first substrate 110 and the display medium layer 130. However, the above-mentioned structures of shape is only used for description and is not used to limit the disclosure.

A shape of the package layer 140 may be determined according to structures of the first substrate 110, the second substrate 120, and the display medium layer 130. For example, the package layer 140 may include a top package portion 142 and an outer convex portion 144 (including a side package portion 144A and a bottom package portion 144B) that are formed in a one-piece form. The top package portion 142 overlaps and covers the first substrate 110. In some embodiments, the top package portion 142 may overlap a projection P120 of the second substrate 120 along the Z direction. For example, dashed lines surrounding the top package portion 142 in FIGS. 1 and 2 is the projection P120 of the second substrate 120 along the Z direction. The outer convex portion 144 may outward from the top package portion 142. When the second substrate 120 is rectangular, the top package portion 142 is also rectangular, and the package layer 140 has four outer convex portions 144 protruding outward along respective sides. Each of the outer convex portions 144 may include, for example, the side package portion 144A and the bottom package portion 144B. The side package portion 144A is a portion extending outward along one side of the top package portion 142 by a certain extension length L144A, and the bottom package portion 144B is a portion extending outward from the side package portion 144A by a certain extension length L144B. In some embodiments, the extension length L144A may be determined according to an overall thickness TA of the stack structure of the first substrate 110, the second substrate 120, and the display medium layer 130. For example, the extension length L144A may be approximately equal to the overall thickness TA (or may be added with twice a thickness T140 of the package layer 140). The extension length L144B of the bottom package portion 144B extending outward from the side package portion 144A may be adjusted according to design requirements.

As shown in FIGS. 1 to 3, each of the outer convex portions 144 may protrude outward from one side of the top package portion 142 and have a width that decreases as it is farther away from the top package portion 142. In some embodiments, when viewed along the Z direction, the package layer 140 may have a rectangular shape with corners cut, but the disclosure is not limited thereto. For convenience of description, the shape of the package layer 140 will be described as octagonal in the following, but the disclosure is not limited thereto. The package layer 140 has, for example, four parallel side walls S140 and four inclined side walls X140. Each of the parallel side walls S140 is located at an end of the corresponding convex portion 144 and is substantially parallel to one side of the top package portion 142 (that is, one side of the projection P120). For example, each of the parallel side walls S140 is parallel to one of the X direction and the Y direction. The inclined side wall X140 is inclined relative to the parallel side wall S140, and is connected between the parallel side walls S140 on two adjacent sides. A corner of the top package portion 142 (that is, a corner of the projection P120) may fall on the inclined side wall X140. The inclined side wall X140 may be divided into side walls S144 of the convex portions 144 on two adjacent sides by the corner of the top package portion 142. The side walls S144 of the convex portions 144 on the two adjacent sides may be parallel to each other and extend along the same linear trajectory, but the disclosure is not limited thereto. The side wall S144 of each of the convex portions 144 may include a side wall S144A of the side package portion 144A and a side wall S144B of the bottom package portion 144B. The side wall S144A of the side package portion 144A and the side wall S144B of the bottom package portion 144B may be parallel to each other and extend along the same linear trajectory.

In some embodiments, the package layer 140 has waterproof properties. For example, a water vapor transmission rate (WVTR) of the package layer 140 may be <0.1 g/m²/day. In some embodiments, the package layer 140 has plasticity and/or stretchability. For example, the package layer 140 may be made of a plastic material, for example, made by using a thermoplastic material or a stretchable material. In some embodiments, a material of the package layer 140 includes polychlorotrifluoroethylene (PCTFE), cyclic olefin copolymer (COC), or a combination thereof. In some embodiments, the material of the package layer 140 includes a composite material of polychlorotrifluoroethylene (PCTFE) and cyclic olefin copolymer (COC) and a composite material of polychlorotrifluoroethylene (PCTFE) and polyethylene terephthalate (PET). The package layer 140 may also be made of a flexible material. The flexible material may include the thermoplastic materials or a bendable material. In some embodiments, the package layer 140 may include a polymer material and an inorganic material layer disposed in the polymer material. The polymer material includes polyethylene terephthalate (PET), polyimide (PI), polyethylene naphthalate (PEN), and other polymer materials. A material of the inorganic material layer may include an inorganic material layer with waterproof properties (which may also be understood as an inorganic waterproof layer), and the inorganic waterproof layer is disposed in the polymer material. The material of the inorganic material layer with the waterproof properties (the inorganic waterproof layer) includes inorganic materials such as silicon oxide (SiO₂), silicon nitride (Si₃N₄), silicon oxynitride (SiOₓN_{y}). The inorganic waterproof layer may be a multi-layer composite material formed by the above inorganic materials or a combination thereof. In some embodiments, the package layer 140 is a multi-layer stack structure formed by the polymer material and the inorganic waterproof layer, and the inorganic waterproof layer may be disposed at a layer of a neutral plane in the multi-layer stack structure, so that the inorganic waterproof layer will not be subject to compressive or tensile stress and cause rupture when bent and packaged.

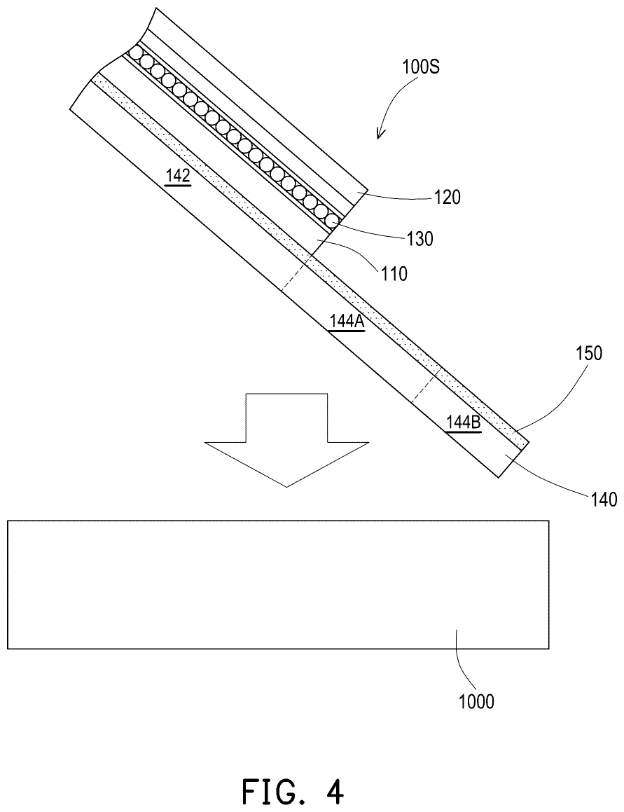

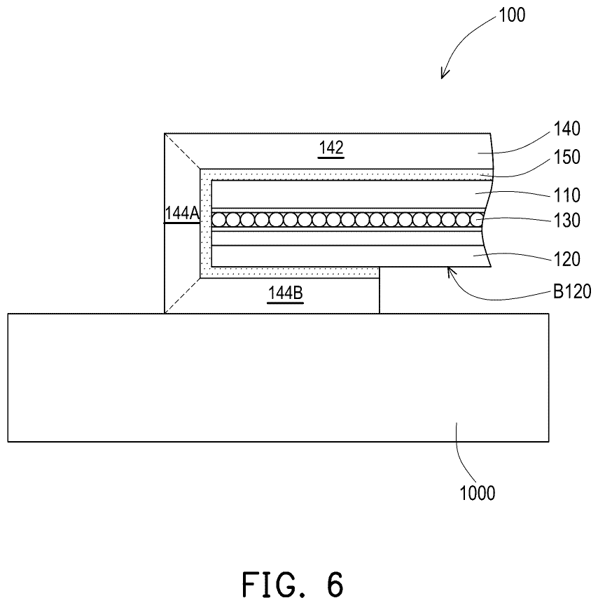

In some embodiments, the outer convex portion 144 of the package layer 140 may be bent along arrows A1 to A4 in FIG. 1 to cover the stack structure of the first substrate 110, the second substrate 120, and the display medium layer 130. In some embodiments, the package layer 140 may be attached to the stack structure of the first substrate 110, the second substrate 120 and the display medium layer 130 through an adhesion layer (not shown). For example, FIGS. 4 to 6 schematically show a portion of processes of manufacturing an electric paper display panel. In FIG. 4, a semi-finished display panel 110S may be placed on a heating device 1000. The semi-finished display panel 110S includes, in addition to the aforementioned first substrate 110, second substrate 120, display medium layer 130, and package layer 140, further includes an adhesion layer 150. The descriptions in FIGS. 1 to 3 may be referred for the structure and stacking relationship of the first substrate 110, the second substrate 120, the display medium layer 130, and the package layer 140. The adhesion layer 150 is disposed on the package layer 140 and is specifically disposed on a side of the package layer 140 facing the stack structure of the first substrate 110, the second substrate 120, and the display medium layer 130. The adhesion layer 150 is, for example, used to attach the package layer 140 to the first substrate 110, the second substrate 120, and the display medium layer 130.

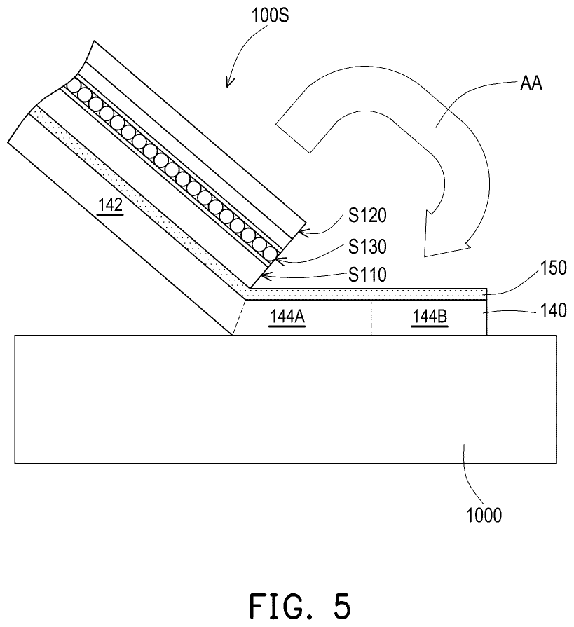

In FIG. 5, the heating device 1000 may perform heating, and a heating temperature thereof is set to be higher than a room temperature and less than 120° C., for example. In some embodiments, the heating temperature may be set to 85° C. In some embodiments, the heating temperature may be set to a temperature that allows the package layer 140 to be thermoformed. At the same time, in FIG. 5, the stack structure of the first substrate 110, the second substrate 120, and the display medium layer 130 may be flipped along an arrow AA to bend the package layer 140. For example, the package layer 140 may be bent along a junction of the top package portion 142 and the side package portion 144A until the side package portion 144A is attached to the stack structure of the first substrate 110, the second substrate 120, and the display medium layer 130. The arrow AA may be used to describe one of the arrows A1 to A4 in FIG. 1. In some embodiments, a step of bending the package layer 140 along the arrows A1 to A4 in FIG. 1 causes the convex portion 144 to be bent from an orientation in which an original normal direction is parallel to the Z direction in FIG. 1 to the normal direction perpendicular to the Z direction in FIG. 1. In this way, the side package portion 144A of the convex portion 144 may extend from the first substrate 110 to the second substrate 120 and be attached to the side wall S110 of the first substrate 110, the side wall S130 of the display medium layer 130, and the side wall S120 of the second substrate 120 through the adhesion layer 150. At this time, the side package portion 144A and the bottom package portion 144B of the convex portion 144 are both oriented such that the normal direction is perpendicular to the Z direction in FIG. 1, and the bottom package portion 144B of the convex portion 144 protrudes outside the first substrate 110.

Then, the stack structure of the first substrate 110, the second substrate 120, and the display medium layer 130 may continue to be flipped along the arrow AA in FIG. 5. At this time, the package layer 140 may be bent along a junction of the side package portion 144A and the bottom package portion 144B until the bottom package portion 144B is attached to a backside surface B120 of the second substrate 120. In other words, the convex portion 144 of the package layer 140 may be bent again, so that the bottom package portion 144B is bent from an orientation in which the normal direction is perpendicular to the Z direction in FIG. 1 to the normal direction parallel to the Z direction in FIG. 1. After the package layer 140 is substantially conformally attached to the stack structure of the first substrate 110, the second substrate 120, and the display medium layer 130, an electric paper display panel 100 may be completed. At this time, the top package portion 142, the side package portion 144A, and the bottom package portion 144B of the package layer 140 form a horizontal U-shape to cover a side wall of the stack structure of the first substrate 110, the second substrate 120, and the display medium layer 130.

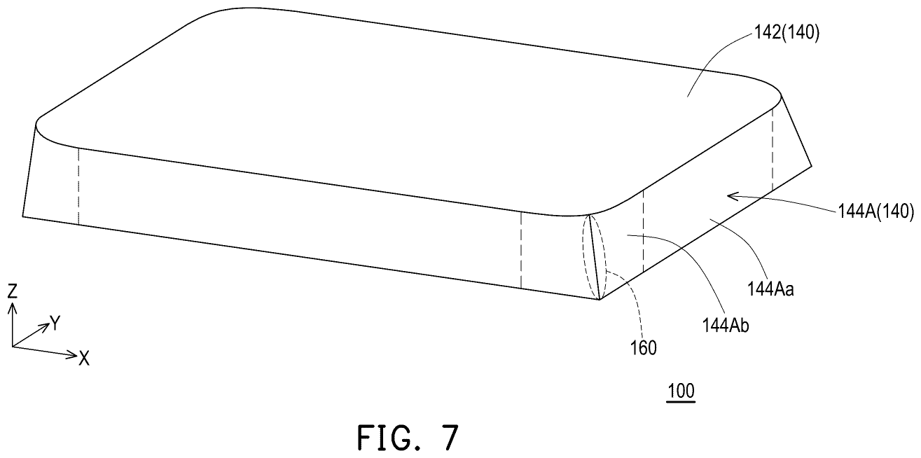

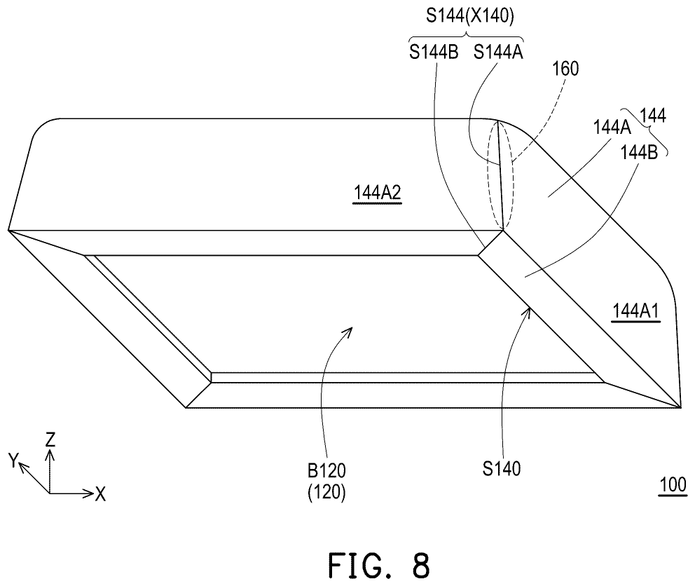

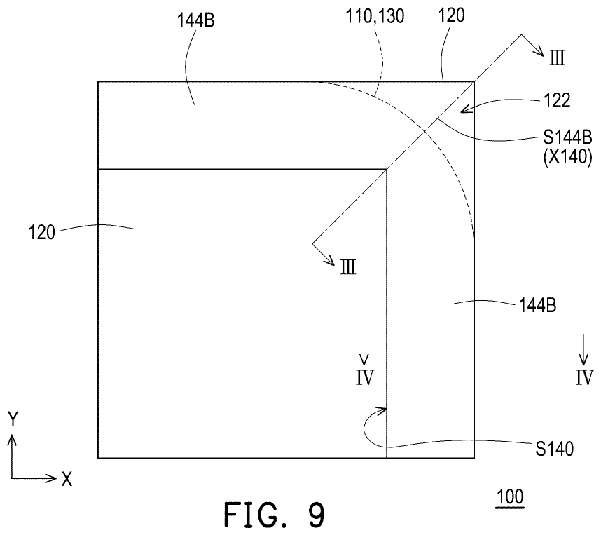

FIG. 7 is a three-dimensional view of an electric paper display panel from a top view according to an embodiment of the disclosure. FIG. 8 is a three-dimensional view of an electric paper display panel from a bottom view according to an embodiment of the disclosure. FIG. 9 is a partial bottom view of an electric paper display panel according to an embodiment of the disclosure. The electric paper display panel 100 in FIGS. 7 to 9 includes the stack structure of the first substrate 110, the second substrate 120, and the display medium layer 130 and the package layer 140. The stack structure of the first substrate 110, the second substrate 120, and the display medium layer 130 is covered by the package layer 140, so details thereof are not shown in FIGS. 7 to 9. The aforementioned descriptions in FIGS. 1 to 6 may be referred for related descriptions of the stack structure of the first substrate 110, the second substrate 120, and the display medium layer 130.

Referring to the aforementioned descriptions in FIGS. 1 to 6, the top package portion 142 of the package layer 140 corresponds to an outline of the second substrate 120 and is attached to the first substrate 110. The side package portion 144A of the package layer 140 extends from the first substrate 110 to the second substrate 120, and is attached to the side wall S110 of the first substrate 110, the side wall S120 of the second substrate 120, and the side wall S130 of the display medium layer 130. The bottom package portion 144B of the package layer 140 covers the backside surface B120 of the second substrate 120. For convenience of description, the side package portions 144A located on adjacent sides of the top package portion 142 in FIG. 8 are described as a side package portion 144A1 and a side package portion 144A2. The side wall S144A of the side package portion 144A1 and the side wall S144A of the side package portion 144A2 may be disposed adjacent to each other, and the side wall S144A of the side package portion 144A1 and the side wall S144A of the side package portion 144A2 are essentially the inclined side wall X140 in FIG. 3.

In some embodiments, the electric paper display panel 100 may further include a waterproof glue 160, and the waterproof glue 160 may be disposed along the side wall S144A of the side package portion 144A. For example, the waterproof glue 160 may be disposed between the side wall S144A of the side package portion 144A1 and the side wall S144A of the side package portion 144A2, and adhere the side wall S144A of the side package portion 144A1 and the side wall S144A of the side package portion 144A2 to each other. Dashed lines in FIGS. 7 and 8 only schematically represent positions where the waterproof glue 160 may be disposed, and are not used to limit a coating width of the waterproof glue 160. In some embodiments, the waterproof glue 160 may also extend between the side walls S144B of the two adjacent bottom package portions 144B. The waterproof properties provided by the waterproof glue 160 helps to protect the display medium layer 130 and avoid damage to the components caused by water penetration.

Referring to the aforementioned descriptions in FIGS. 1 to 6, the second substrate 120 has the bottom corner portion 122 that extends beyond the display medium layer 130 and the first substrate 110. In some embodiments, the side package portion 144A of the package layer 140 may be attached to the bottom corner portion 122 of the second substrate 120, and specifically includes a portion 144Aa that is close to the side wall S110 of the first substrate 110 and the side wall S130 of the display medium layer 130 and a portion 144Ab that is partially attached to a front side surface of the bottom corner portion 122. In this way, the portion 144Ab of the side package portion 144A may be bent into a three-dimensional shape at the bottom corner portion 122 of the second substrate 120, while the portion 144Aa is not parallel. In some embodiments, referring further to FIG. 2, the portion 144Aa may be attached to the middle section S110a of the side wall S110 of the first substrate 110 and the middle section S130a of the side wall S130 of the display medium layer 130, and the portion 144Ab may be attached to the corner section S110b of the side wall S110 of the first substrate 110 and the corner section S130b of the side wall S130 of the display medium layer 130.

As shown in FIGS. 8 and 9, the package layer 140 may encapsulate a large portion of an outer surface of the stack structure of the first substrate 110, the second substrate 120, and the display medium layer 130. For example, in the stack structure of the first substrate 110, the second substrate 120, and the display medium layer 130, only a portion of the backside surface B120 of the second substrate 120 is not covered by the package layer 140. The parallel side walls S140 located at an end of the bottom package portion 144B of the package layer 140 enclose an opening area on the backside surface B120 of the second substrate 120, and the backside surface B120 of the second substrate 120 is only exposed in the opening area. In some embodiments, both the second substrate 120 and the package layer 140 have waterproof properties, and the display medium layer 130 of the electric paper display panel 100 is not easily damaged by the water penetration, which helps to improve service life of the electric paper display panel 100.

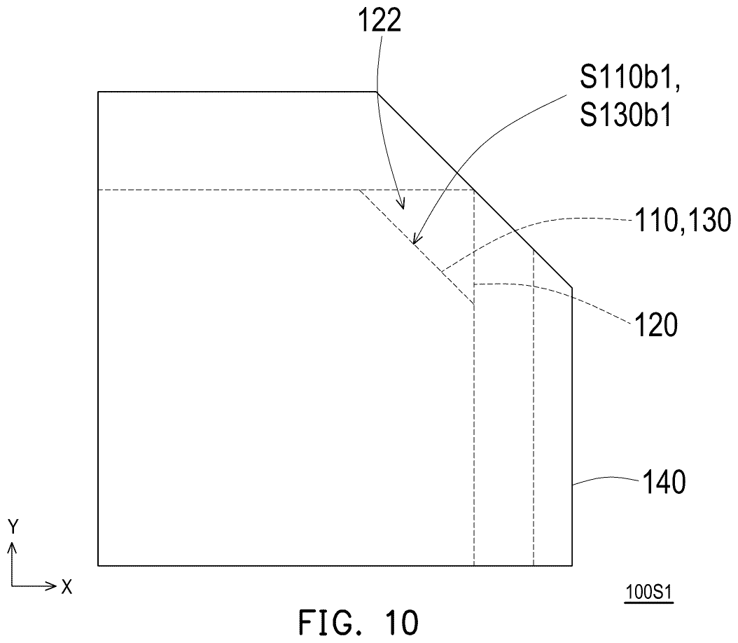

FIG. 10 is a schematic partial top view of a semi-finished electric paper display panel according to an embodiment of the disclosure. A semi-finished electric paper display panel 100S1 in FIG. 10 has the same components as the semi-finished electric paper display panel 100S, including the first substrate 110, the second substrate 120, the display medium layer 130, and the package layer. However, in the semi-finished electric paper display panel 100S1, a corner section S110b1 of the side wall of the first substrate 110 and a corner section S130b1 of the side wall of the display medium layer 130 extend along a straight line inclined relative to the X direction/Y direction. In this way, the bottom corner portion 122 of the second substrate 120 is substantially triangular in a top-view direction.

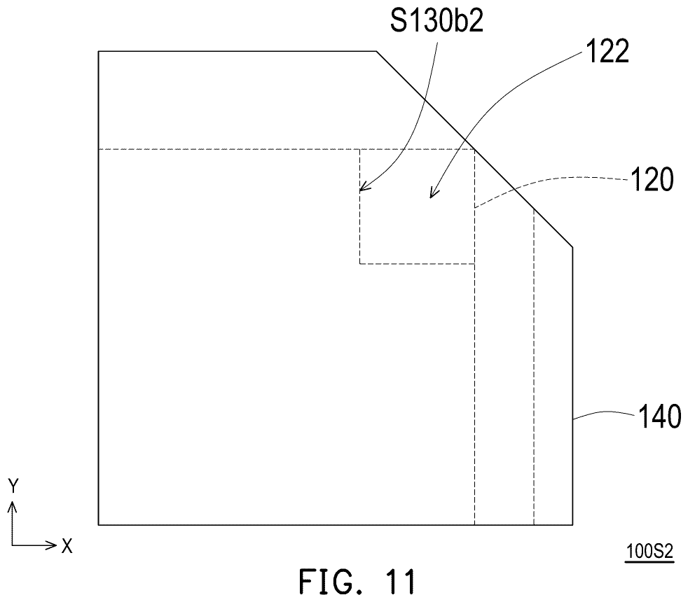

FIG. 11 is a schematic partial top view of a semi-finished electric paper display panel according to an embodiment of the disclosure. A semi-finished electric paper display panel 100S2 in FIG. 11 has the same components as the semi-finished electric paper display panel 100S, including the first substrate 110, the second substrate 120, the display medium layer 130, and the package layer. However, in the semi-finished electric paper display panel 100S2, a corner section S110b2 of the side wall of the first substrate 110 and a corner section S130b2 of the side wall of the display medium layer 130 have transitions. Turning angles of the corner section S110b2 and the corner section S130b2 may be adjusted according to designs. In this way, the bottom corner portion 122 of the second substrate 120 is substantially quadrangular in the top-view direction, including a square, a rectangle, a rhombus, and a trapezoid.

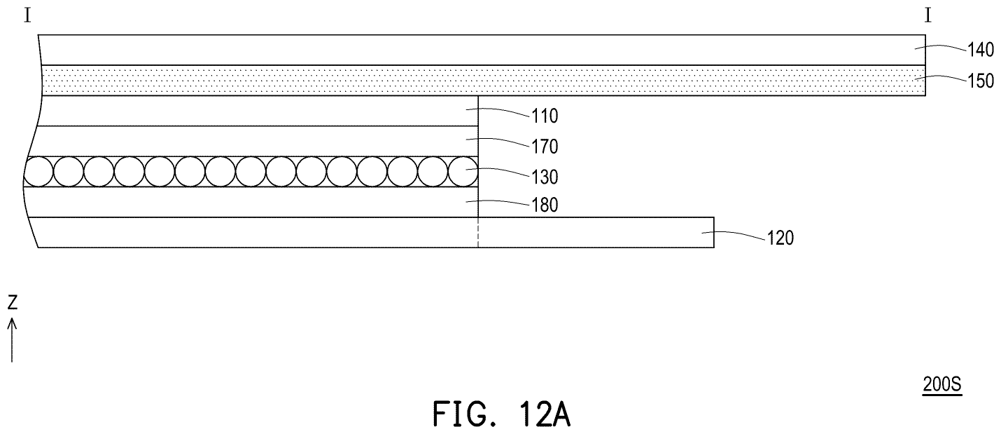

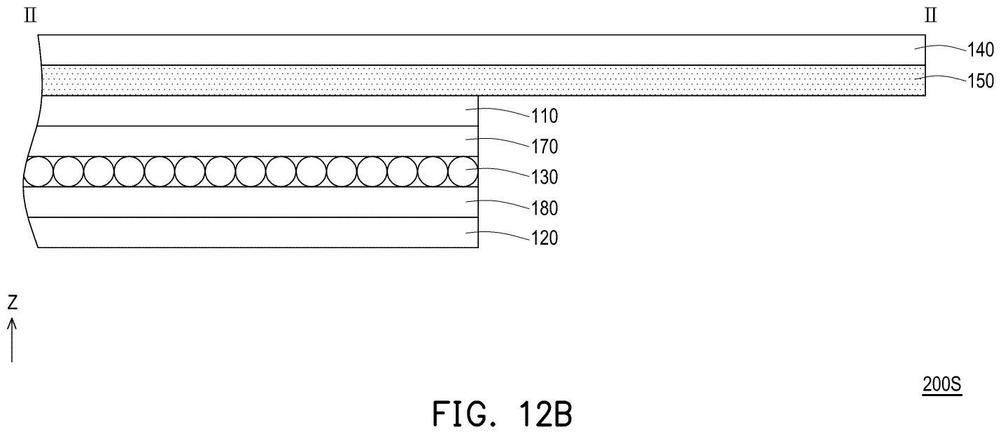

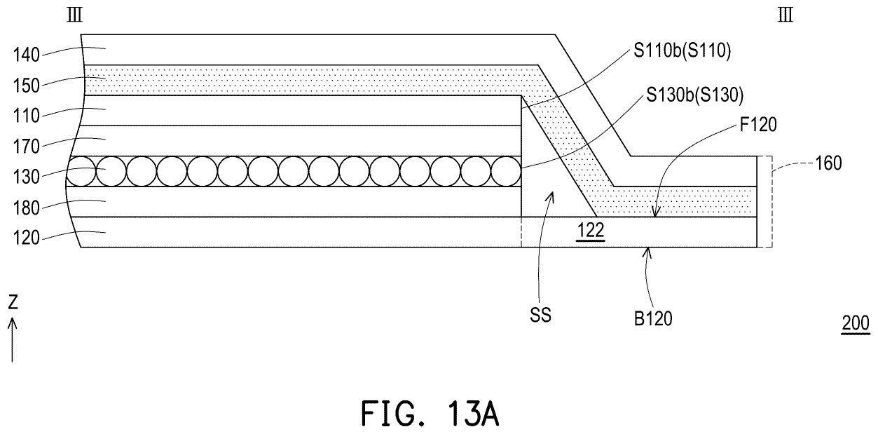

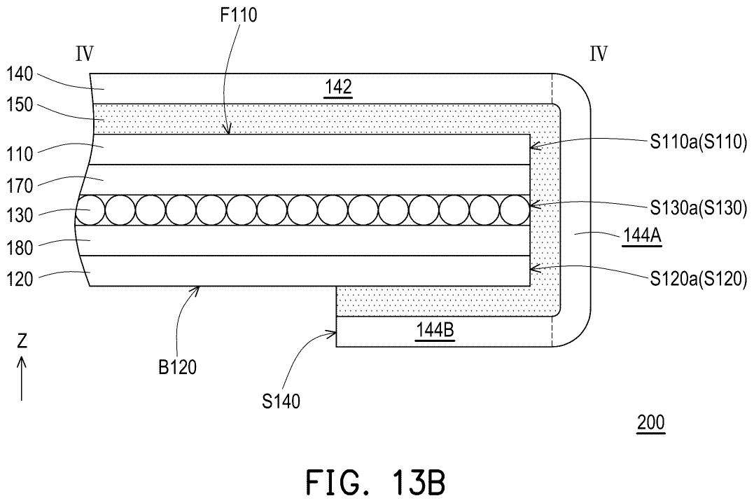

FIG. 12A is a schematic partial cross-sectional view of a semi-finished electric paper display panel according to an embodiment of the disclosure. FIG. 12B is schematic partial cross-sectional view of a semi-finished electric paper display panel according to an embodiment of the disclosure. Structures in FIGS. 12A and 12B may be used to describe the embodiment of the semi-finished electric paper display panel 100S in FIG. 3, and for example, respectively present cross-sectional structures corresponding to section lines I-I and II-II in FIG. 3. FIG. 13A is a schematic partial cross-sectional view of an electric paper display panel made of the semi-finished electric paper display panel in FIG. 12A. FIG. 13B is a schematic partial cross-sectional view of an electric paper display panel made of the semi-finished electric paper display panel in FIG. 12B. Structures in FIGS. 13A and 13B may be used to describe the embodiment of the electric paper display panel 100 in FIG. 9, and for example, respectively present cross-sectional structures corresponding to section lines III-III and IV-IV in FIG. 9.

In FIGS. 12A and 12B, a semi-finished electric paper display panel 200S includes the first substrate 110, the second substrate 120, the display medium layer 130, the package layer 140, and the adhesion layer 150 described in the aforementioned embodiment, and further includes a first electrode layer 170 and a second electrode layer 180. Descriptions of components indicated by the same reference numerals in FIGS. 1 to 10 may be referred for the first substrate 110, the second substrate 120, the display medium layer 130, the package layer 140, and the adhesion layer 150. In FIGS. 12A and 12B, the first electrode layer 170 is disposed between the first substrate 110 and the display medium layer 130, and the second electrode layer 180 is disposed between the second substrate 120 and the display medium layer 130. Sizes and outlines of the first electrode layer 170 and the second electrode layer 180 may substantially correspond to the display medium layer 130. Therefore, the first electrode layer 170, the second electrode layer 180, the display medium layer 130, and the first substrate 110 have substantially the same shape and size in a top view (parallel to the Z direction). The second substrate 120 has the bottom corner portion 122 that extends beyond the display medium layer 130 in FIG. 12A, and is substantially aligned with the display medium layer 130 in FIG. 12B.

The display medium layer 130 mainly includes an electric paper display material, and the water penetration may damage such material. In some embodiments, the second substrate 120 and the package layer 140 disposed on an outer side have the waterproof properties, so that the water is not easily penetrate into the display medium layer 130 from the second substrate 120 or the package layer 140, which helps to ensure service life of the display medium layer 130. In some embodiments, the first substrate 110 may also optionally have the waterproof properties. In addition, referring to the aforementioned description, the package layer 140 has plasticity and/or stretchability.

In some embodiments, materials of the first substrate 110 and the second substrate 120 may both have the waterproof properties. For example, the materials of the first substrate 110 and the second substrate 120 include glass, metal, or polymers with the waterproof properties. The polymers with the waterproof properties include polychlorotrifluoroethylene (PCTFE), cyclic olefin copolymer (COC), a composite material of polychlorotrifluoroethylene (PCTFE) and cyclic olefin copolymer (COC), a composite material of polychlorotrifluoroethylene (PCTFE) and polyethylene terephthalate (PET), or a combination thereof. In some embodiments, the first substrate 110 and the second substrate 120 may be composite substrates and include a body material and a waterproof material disposed in the body material. The waterproof material may be embedded in the body material in layers. The body material may include a polymer material (e.g., polyethylene terephthalate (PET) or the like), and the waterproof material may include silicon oxide, silicon nitride, or silicon oxynitride. In some embodiments, the first substrate 110 is not required to have the waterproof properties, and the second substrate 120 has the waterproof properties. The material of the first substrate 110 may include polymers other than the above-mentioned polymers with the waterproof properties.

In some embodiments, the material of the package layer 140 includes a waterproof plastic and/or stretchable polymer, which includes, for example, polychlorotrifluoroethylene (PCTFE), cyclic olefin copolymer (COC), a composite material of polychlorotrifluoroethylene (PCTFE) and cyclic olefin copolymer (COC), a composite material of polychlorotrifluoroethylene (PCTFE) and polyethylene terephthalate (PET), or a combination thereof. In some embodiments, the package layer 140 may be a composite material, and include a body material and a waterproof material disposed in the body material. The body material may be a polymer material (e.g., polyethylene terephthalate (PET) or the like), and the waterproof material includes silicon oxide, silicon nitride, or silicon oxynitride.

In some embodiments, materials of the first electrode layer 170 and the second electrode layer 180 include indium tin oxide (ITO), aluminum, poly(3,4-ethylenedioxythiophene) (PEDOT), silver glue, carbon glue, or a combination thereof. In some embodiments, the first electrode layer 170 and the second electrode layer 180 may be selected to be stretchable conductive materials, such as PEDOT materials, stretchable silver glue, stretchable carbon glue, or the like. Although the first electrode layer 170 and the second electrode layer 180 are shown as being unpatterned in the drawings, in fact, the first electrode layer 170 and the second electrode layer 180 may be patterned according to the designs.

In some embodiments, a manufacturing method of the semi-finished electric paper display panel 200S may include the following. The first electrode layer 170 and the second electrode layer 180 are pre-formed on the first substrate 110 and the second substrate 120 respectively, and are then disposed on two opposite sides of the display medium layer 130 by attachment. Then, the package layer 140 is attached to the first substrate 110 through the adhesion layer 150. The first electrode layer 170, the first substrate 110, the adhesion layer 150, and the package layer 140 may be made of materials with good light transmittance to allow display light of the display medium layer 130 to pass through. The adhesion layer 150 may be made of an adhesive material with waterproof properties.

The semi-finished electric paper display panel 200S may be formed into an electric paper display panel 200 in FIGS. 13A and 13B through a manufacturing process in FIGS. 4 to 6. The electric paper display panel 200 includes the first substrate 110, the second substrate 120, the display medium layer 130, the package layer 140, the adhesion layer 150, the first electrode layer 170, and the second electrode layer 180, and further optionally includes the waterproof glue 160 described in FIGS. 7 and 8. As shown in FIG. 13A, the package layer 140 may be attached to the bottom corner portion 122 of the second substrate 120 through the adhesion layer 150 and specifically attached to a front side surface F120 of the second substrate 120. At this time, the package layer 140 does not necessarily be closely attached to the corner section S110b of the side wall S110 of the first substrate 110 and the corner section S130b of the side wall S130 of the display medium layer 130. Therefore, a stack structure of the first substrate 110, the first electrode layer 170, the second electrode layer 180, and the display medium layer 130, the second substrate 120, and the package layer 140 enclose a sealed space SS. The second substrate 120, the package layer 140, and the adhesion layer 150 all have the waterproof properties, and adhesion between the second substrate 120 and the package layer 140 helps to resist penetration of water.

In FIG. 13B, the package layer 140 may include the top package portion 142, the side package portion 144A, and the bottom package portion 144B. The top package portion 142 of the package layer 140 may be attached to a front side surface F110 of the first substrate 110 through the adhesion layer 150. The side package portion 144A of the package layer 140 may be attached to the middle section S110a of the side wall S110 of the first substrate 110, the middle section S120a of the side wall S120 of the second substrate 120, the middle section S130a of the side wall S130 of the display medium layer 130, a side wall of the first electrode layer 170, and a side wall of the second electrode layer 180 through the adhesion layer 150. In addition, the package layer 140 may be further bent, so that the bottom package portion 144B is attached to the backside surface B120 of the second substrate 120. The package layer 140 has the waterproof properties, so adhesion of the package layer 140 may resist the penetration of the water. In some embodiments, covering of the package layer 140 may provide an ideal waterproof package, so that the electric paper display panel 200 has a narrow-border package structure.

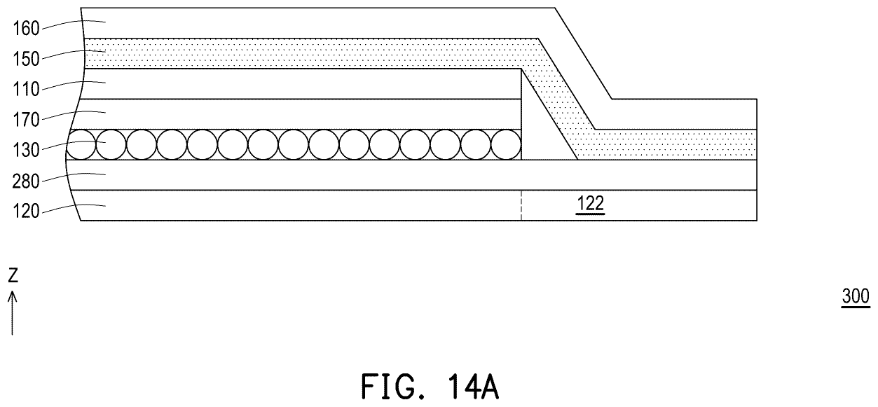

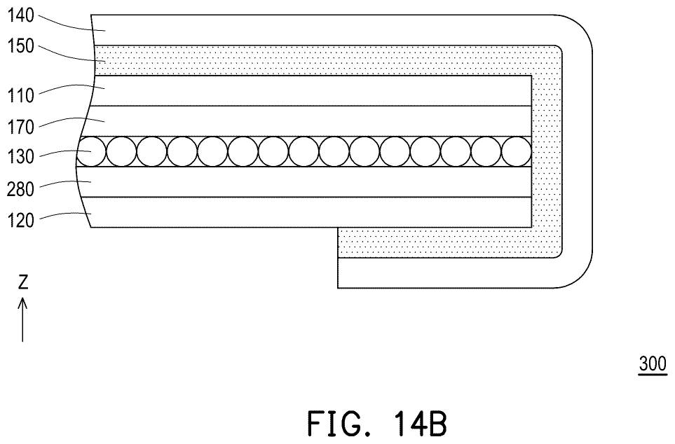

FIGS. 14A and 14B are two schematic partial cross-sectional views of an electric paper display panel according to an embodiment of the disclosure. An electric paper display panel 300 in FIGS. 14A and 14B may be a modified implementation of the aforementioned electric paper display panel 200. Therefore, the same reference numerals in the two embodiments refer to the same components, and the descriptions of the components may be referenced to each other. The electric paper display panel 300 includes the first substrate 110, the second substrate 120, the display medium layer 130, the package layer 140, the adhesion layer 150, the first electrode layer 170, and a second electrode layer 280. The second electrode layer 280 may be used as a modified implementation of the second electrode layer 180 of the electric paper display panel 200. In this embodiment, an extension area of the second electrode layer 280 is substantially equal to an area of the second substrate 120. For example, when viewed along the Z direction, an outline of the second electrode layer 280 substantially overlaps the outline of the second substrate 120. In addition, the adhesion layer 150 may be in contact with the second electrode layer 280. The package layer 140 may be attached to the second electrode layer 280 at the bottom corner portion 122 of the second substrate 120. In addition, a structure in FIG. 14B is substantially the same as that in FIG. 13B, so the description in FIG. 13B may also be applied to FIG. 14B.

In addition to the materials mentioned in the descriptions in FIGS. 13A and 13B, in some embodiments, the second substrate 120 and the second electrode layer 280 may optionally have stretchable properties, and the second substrate 120 still has the waterproof properties. In some embodiments, in addition to the second substrate 120 and the second electrode layer 280, the first substrate 110 and the first electrode layer 170 may also optionally have the stretchable properties. In some embodiments, waterproof properties of the second substrate 120 may be better than those of the first substrate 110, or the first substrate 110 may not have good waterproof properties. In some embodiments, the display medium layer 130 may optionally have the stretchable properties. In some embodiments, an overall stack structure of the first substrate 110, the second substrate 120, the display medium layer 130, the first electrode layer 170, and the second electrode layer 280 has the stretchable properties. In some embodiments, the package layer 140 may optionally have the stretchable properties in addition to having the waterproof properties.

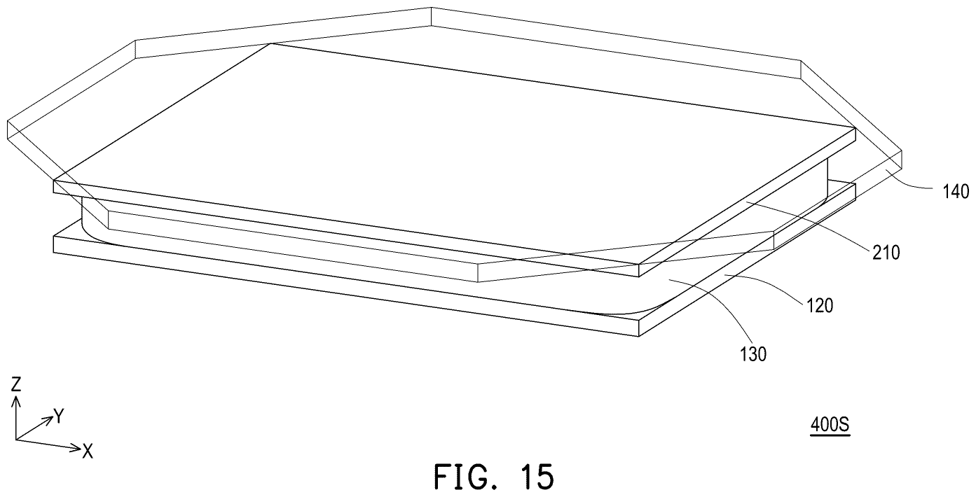

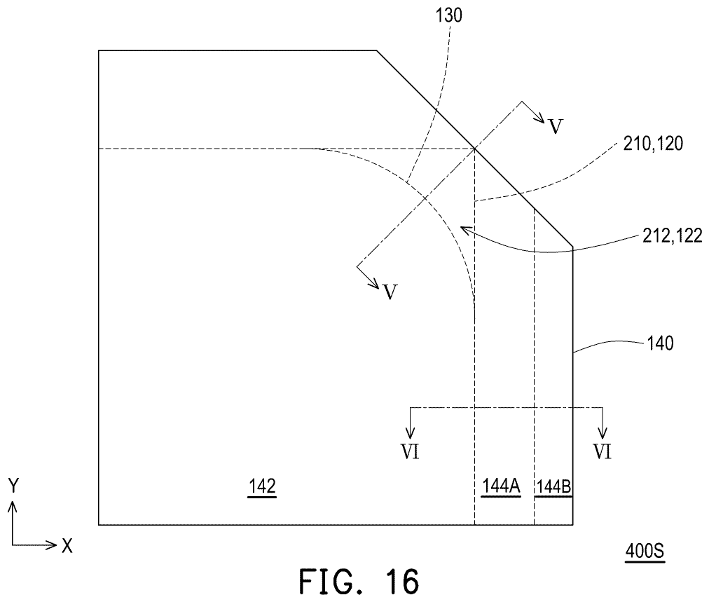

FIG. 15 is a schematic perspective view of a semi-finished electric paper display panel according to an embodiment of the disclosure. FIG. 16 is a partial top view of the semi-finished electric paper display panel in FIG. 15. A semi-finished electric paper display panel 400S in FIGS. 15 and 16 is similar to the semi-finished electric paper display panel 100S in the aforementioned embodiment. Therefore, the descriptions in FIGS. 1 to 9 may be applied to this embodiment. The semi-finished electric paper display panel 400S includes a first substrate 210, the second substrate 120, the display medium layer 130, and the package layer 140. The descriptions in FIGS. 1 to 9 may be referred for a configuration relationship and shape design of the second substrate 120, the display medium layer 130, and the package layer 140, but the first substrate 210 is different from that in the aforementioned embodiment. Specifically, a size and shape of the first substrate 210 are substantially equal to the second substrate 120. As shown in FIGS. 15 and 16, the first substrate 210 and the second substrate 120 have substantially the same rectangular shape when viewed along the Z direction. Therefore, the first substrate 210 and the second substrate 120 overlap in FIG. 16. In this embodiment, a main difference between the first substrate 210 and the first substrate 110 in the aforementioned embodiment is the shape. Therefore, the descriptions of the materials, characteristics, and stacking relationship of the first substrate 110 in the aforementioned embodiment may be applied to this embodiment.

On a plane of the X direction and the Y direction, the first substrate 210 extends beyond the display medium layer 130 and overlaps the bottom corner portion 122 of the second substrate 120, so that the display medium layer 130 is retracted relative to the first substrate 210 and the second substrate 120 at the corner. In this way, the first substrate 210 has a top corner portion 212 that extends beyond the display medium layer 130, and shapes of the bottom corner portion 122 and the top corner portion 212 may be determined by a corner shape of the display medium layer 130. For example, the shapes of the bottom corner portion 122 and the top corner portion 212 may be the shape of the bottom corner portion 122 in any one of FIGS. 3, 10, and 11.

The package layer 140 is a plastic material, and according to a configuration relationship between the components, the package layer 140 may include the top package portion 142, the side package portion 144A, and the bottom package portion 144B. The top package portion 142 may be substantially bonded to the first substrate 210 and correspond to an outline of the first substrate 210. The semi-finished electric paper display panel 400S may be processed with reference to the manufacturing process in FIGS. 4 to 6 to form a required finished product. Therefore, the description of the aforementioned embodiments may be referred for the shape of the package layer 140, the relative relationship between the top package portion 142, the side package portion 144A, and the bottom package portion 144B, etc.

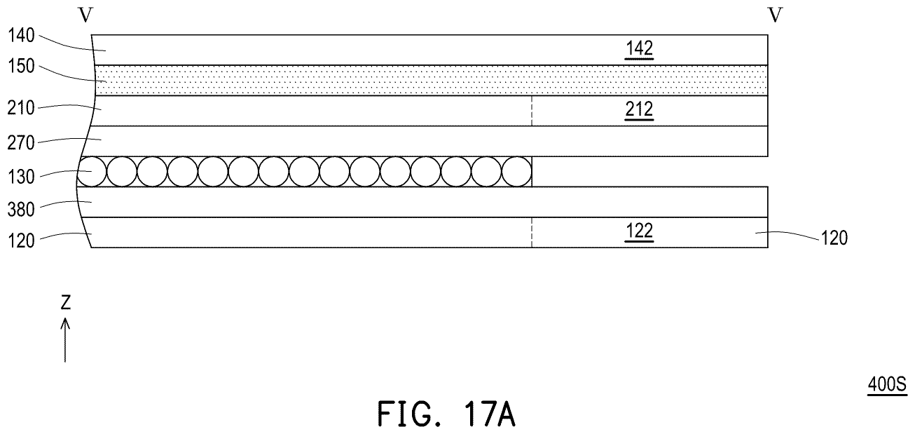

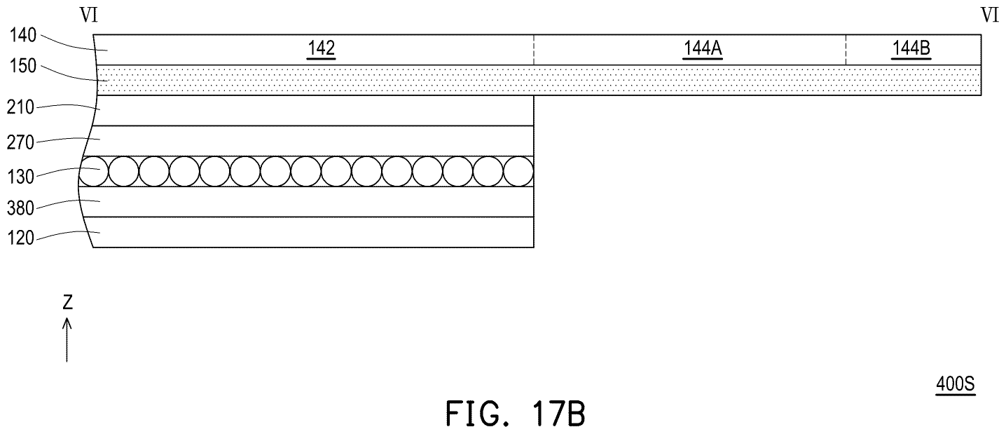

FIGS. 17A and 17B are two schematic partial cross-sectional views of a semi-finished electric paper display panel. Structures in FIGS. 17A and 17B may be used to describe the implementation of the semi-finished electric paper display panel 400S in FIGS. 15 and 16, and for example, respectively present cross-sectional structures corresponding to a section line V-V and a section line VI-VI in FIG. 16. Specifically, in addition to the first substrate 210, the second substrate 120, the display medium layer 130, and the package layer 140, the semi-finished electric paper display panel 400S also includes the adhesion layer 150, a first electrode layer 270, and a second electrode layer 380. The first electrode layer 270 and the second electrode layer 380 extend to substantially the same size as the first substrate 210 and the second substrate 120 respectively. The first electrode layer 170 and the second electrode layer 180 (or the second electrode layer 280) in the aforementioned embodiment may be referred for the descriptions of materials, stacking relationships, etc. of the first electrode layer 270 and the second electrode layer 380.

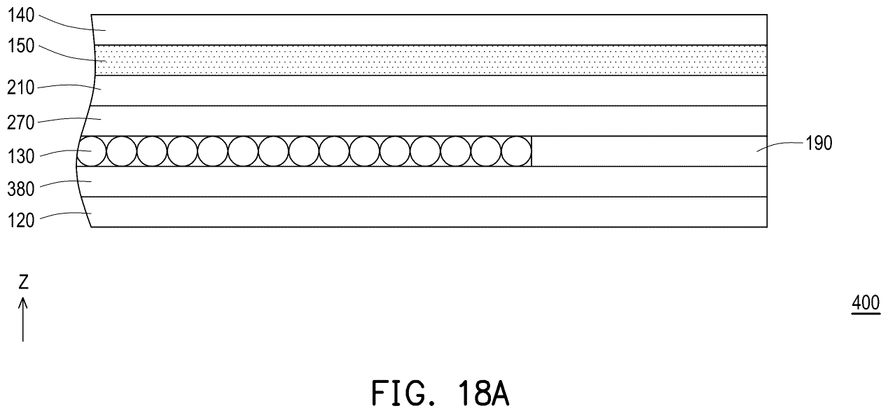

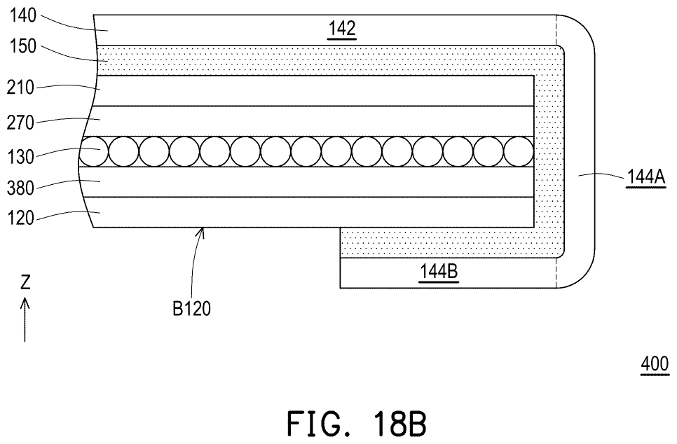

In FIG. 17A, at the bottom corner portion 122 and the top corner portion 212, the first electrode layer 270 and the second electrode layer 380 extend beyond display medium layer 130 and are spaced apart in the Z direction. FIG. 18A is a schematic partial cross-sectional view of an electric paper display panel according to an embodiment of the disclosure. Referring to FIGS. 17A and 18A, a method of processing the semi-finished electric paper display panel 400S may include the following. A sealing material 190 is disposed between the bottom corner portion 122 and the top corner portion 212 to form an electric paper display panel 400 in FIG. 18A. The sealing material 190 is specifically disposed between the first substrate 210 and the second substrate 120 and seals the display medium layer 130 at the bottom corner portion 122 and the top corner portion 212.

FIG. 18B is a schematic partial cross-sectional view of an electric paper display panel according to an embodiment of the disclosure. Referring to FIGS. 17B and 18B, the method of processing the semi-finished electric paper display panel 400S may include performing the steps in FIGS. 4 to 6 to bend the package layer 140 and cover a stack structure of the first substrate 210, the first electrode layer 270, the display medium layer 130, the second electrode layer 380, and the second substrate 120. The top package portion 142 of the package layer 140 may be attached to the first substrate 210 through the adhesion layer 150. The side package portion 144A of the package layer 140 may be attached to the first substrate 210, the first electrode layer 270, the display medium layer 130, the second electrode layer 380, and a side wall of the second substrate 120 through the adhesion layer 150. The bottom package portion 144B of the package layer 140 may be attached to the backside surface B120 of the second substrate 120 through the adhesion layer 150.

The display medium layer 130 may be completely encapsulated by the second substrate 120, the package layer 140, and the sealing material 190. The second substrate 120, the package layer 140, and the sealing material 190 all have the waterproof properties and may protect the display medium layer 130 from being damaged by the water penetration. The first substrate 210, the second substrate 120, the first electrode layer 270, the display medium layer 130, and the second electrode layer 380 optionally have or do not have the stretchable properties. The first substrate 210, similar to the aforementioned first substrate 110, optionally has or does not have the stretchable properties, optionally has or does not have the waterproof properties, and may allow the display light to pass through. The aforementioned embodiments may be referred for the materials of the second substrate 120 and the package layer 140. The materials of the first electrode layer 170 and the second electrode layer 180 in the aforementioned embodiments may be referred for materials of the first electrode layer 270 and the second electrode layer 380. As shown in FIG. 18B, the electric paper display panel 400 only requires the package layer 140 and the corresponding adhesion layer 150 at the side walls to achieve the ideal package, thereby having the thin package side walls, which helps to implement a design of narrow borders.

Based on the above, in the electric paper display panel according to the embodiment of the disclosure, a stack structure in which the package layer with plasticity and the waterproof properties three-dimensionally covers the display medium layer is used. The electric paper display panel may have the narrow-border package and may also provide a good waterproof effect to protect the display medium layer from damage by the water penetration.

What is claimed is:

1. An electric paper display panel, comprising:
a first substrate;
a second substrate, wherein the first substrate is disposed opposite to the second substrate;
a display medium layer disposed between the first substrate and the second substrate; and
a package layer disposed on the first substrate and comprising a top package portion, a side package portion, and a bottom package portion that are formed in a one-piece form, wherein the top package portion overlaps the first substrate, the side package portion extends from the first substrate to the second substrate, and the bottom package portion covers a bottom surface of the second substrate.

2. The electric paper display panel according to claim 1, wherein the second substrate has a bottom corner portion that extends beyond the display medium layer.

3. The electric paper display panel according to claim 2, wherein the side package portion of the package layer is attached to the bottom corner portion of the second substrate.

4. The electric paper display panel according to claim 2, wherein the first substrate has a top corner portion that extends beyond the display medium layer.

5. The electric paper display panel according to claim 4, further comprising a sealing material disposed between the first substrate and the second substrate, sealing the display medium layer at the bottom corner portion and the top corner portion.

6. The electric paper display panel according to claim 1, further comprising an adhesion layer attaching the package layer to the first substrate, the display medium layer, and the second substrate.

7. The electric paper display panel according to claim 1, further comprising a first electrode layer and a second electrode layer, wherein the first electrode layer is disposed between the first substrate and the display medium layer, and the second electrode layer is disposed between the second substrate and the display medium layer.

8. The electric paper display panel according to claim 7, wherein materials of the first electrode layer and the second electrode layer comprise indium tin oxide (ITO), aluminum, poly(3,4-ethylenedioxythiophene) (PEDOT), silver glue, carbon glue, or a combination thereof.

9. The electric paper display panel according to claim 7, wherein materials of the first electrode layer and the second electrode layer are stretchable conductive materials.

10. The electric paper display panel according to claim 1, wherein materials of the first substrate and the second substrate comprise glass, metal, or polymers with waterproof properties.

11. The electric paper display panel according to claim 1, wherein at least one of the first substrate, the second substrate, and the package layer comprises a body material and a waterproof material disposed in the body material.

12. The electric paper display panel according to claim 11, wherein the waterproof material comprises silicon oxide, silicon nitride, or silicon oxynitride.

13. The electric paper display panel according to claim 1, wherein a material of the package layer comprises polychlorotrifluoroethylene (PCTFE), cyclic olefin copolymer (COC), a composite material of polychlorotrifluoroethylene (PCTFE) and cyclic olefin copolymer (COC), a composite material of polychlorotrifluoroethylene (PCTFE) and polyethylene terephthalate (PET), or a combination thereof.

14. The electric paper display panel according to claim 1, wherein the package layer comprises a polymer material and an inorganic waterproof layer disposed in the polymer material, wherein a material of the inorganic waterproof layer comprises silicon oxide, silicon nitride, silicon oxynitride, or a combination thereof, and the polymer material comprises polyethylene terephthalate, polyimide, polyethylene naphthalate, or a combination thereof.

15. The electric paper display panel according to claim 1, wherein the package layer has stretchability.

16. The electric paper display panel according to claim 1. further comprising a waterproof glue disposed along a side wall of the side package portion.
